(19) United States
(12) Patent Application Publication
(10) Pub. No.: US 2013/0222875 A1
(43) Pub. Date: Aug. 29, 2013

(54) PROJECTION DISPLAY APPARATUS

(71) Applicant: Hiroko Chifu, Tokyo (JP)

(72) Inventor: Hiroko Chifu, Tokyo (JP)

(21) Appl. No.: 13/824,708

(22) PCT Filed: Oct. 7, 2010
(86) PCT No.: PCT/JP2010/067675

§ 371 Date: May 6, 2013

(51) Int. Cl. G02B 27/48

(52) U.S. Cl. CPC G02B 27/48
USPC 359/201.1

(57) ABSTRACT

Provided is a projection display apparatus that enlarges and projects an image. The projection display apparatus includes: semiconductor lasers (2r, 2g, and 2b) as light sources; first optical element (5) that refracts light emitted from semiconductor lasers (2r, 2g, and 2b) and outputs the light in a direction different from an incident direction; second optical element (6) that converts the light output from first optical element (5) into a plurality of light fluxes; light modulation element (9) that modulates the light output from second optical element (6) to generate image light; and driving means for rotating or swinging first optical element (6). Rotating or swinging first optical element (5) causes a change with time in the irradiation position of second optical element (6) with the light output from first optical element (5).

### TECHNICAL FIELD

The present invention relates to a projection display apparatus that uses a semiconductor laser as a light source.

### BACKGROUND ART

Recently, as a new light source for the projection display apparatus, a semiconductor laser has been a focus of attention. Light (laser beam) emitted from the semiconductor laser is monochromatic light having high directionality. Accordingly, in the projection display apparatus using the semiconductor laser as the light source, utilization efficiency of light is high, and a color reproduction area is wide. Further, a semiconductor laser consumes less power and has a long life.

However, the laser beam is coherent light having high coherency. Thus, when a screen is irradiated with the laser beam, the laser beam is irregularly reflected due to a concave-convex screen surface, thereby forming speckled patterns (interference fringes) referred to as “speckles”. When speckles appear on an image projected by the projection display apparatus, the viewer sees glare. Such glare is generally referred to as “speckle noise”.

Patent Literature 1 discloses a technology for reducing the speckle noise. Specifically, Patent Literature 1 discloses a projector that includes a diffusing lens for diffusing a laser beam emitted from a semiconductor laser. The diffusing lens is located on the optical axis of the laser beam to be vibrated or rotated. According to Patent Literature 1, vibrating or rotating the diffusing lens causes a continuous change of speckled patterns, and recognition of specific speckled patterns is difficult.

### CITATION LIST

Patent Literature 1: JP2008-122823A

### SUMMARY OF INVENTION

### Problems to be Solved by Invention

The technology described in Patent literature 1 can reduce the speckle noise. However, since the light transmittance of the diffusing lens is about 80% to 90%, light losses are large. In other words, in the technology described in Patent literature 1, there is a trade-off between the reduction effect of the speckle noise and light use efficiency (brightness).

A general projection apparatus includes an optical integrator that converts a light flux applied to a light modulation element into a rectangular light flux and makes luminance distribution uniform. As one optical integrator, a hollow light tunnel having a reflective film deposited on its inner wall surface is known. When the light tunnel is added to the projector disclosed in Patent Literature 1, the laser beam transmitted through the diffusing lens is repeatedly reflected totally in the light tunnel to be made uniform in luminance Thus, to make luminance uniform at the exit end of the light tunnel, the total length of the light tunnel must be made longer to increase the total number of reflection times. However, when the total length of the light tunnel is longer, an optical system is enlarged, interfering with miniaturization of the projector.

As another optical integrator, a microlens array where many micro and rectangular biconvex lenses (microlenses) are integrated in an array is known. When the microlens array is added to the projector disclosed in Patent Literature 1, the laser beam transmitted through the diffusing lens is converted into a plurality of light fluxes having rectangular sections. In this case, the luminance of each light flux output from each microlens is made uniform. However, on the light modulation element, the adjacent light fluxes may partially overlap each other, or a gap may be generated between the adjacent light fluxes. Consequently, irradiation uniformity may be insufficient as a whole.

Each of FIGS. 1A and 1B shows a state where a plurality of light fluxes output from the microlens array is applied to the light modulation element. As shown in FIGS. 1A and 1B, laser beam 110 that enters microlens array 60 is converted into a plurality of light fluxes 110a by microlens array 60. Each light flux 110a that is output from microlens array 60 is applied to light modulation element 90. At this time, as shown in FIG. 1A, in the illumination area of light modulation element 90, the adjacent light fluxes may partially overlap each other. As shown in FIG. 1B, in the illumination area of light modulation element 90, a gap may be generated between the adjacent light fluxes.

### Solution to Problem

According to an aspect of the present invention, a projection display apparatus includes: a semiconductor laser as a light source; a first optical element that refracts light emitted from the semiconductor laser and outputs the light in a direction that is different from an incident direction; a second optical element that converts the light output from the first optical element into a plurality of light fluxes; a light modulation element that modulates the light output from the second optical element to generate image light; and driving means for rotating or swinging the first optical element. Rotating or swinging the first optical element causes a change with time in the irradiation position of the second optical element with the light output from the first optical element.

According to another aspect of the present invention, there is provided a projection display apparatus that enlarges and projects an image. The projection display apparatus includes: a semiconductor laser as a light source; a first optical element that converts light emitted from the semiconductor laser into a plurality of light fluxes; a second optical element through which light output from the first optical element passes; a light modulation element that modulates the light output from the second optical element to generate image light; and driving means for swinging the second optical element. Swinging the second optical element causes a change with time in the irradiation position of the light modulation element with the light output from the second optical element.

### Effects of Invention

According to the present invention, the projection display apparatus capable of projecting an image having limited speckle noise and a uniform luminance distribution can be provided.

### BRIEF DESCRIPTION OF DRAWINGS

FIG. 1A is a schematic view showing the applied state of a light flux output from a microlens array to a light modulation element.

FIG. 1B is a schematic view showing the applied state of a light flux output from a microlens array to a light modulation element.

FIG. 2 is a schematic plan view showing a projection display apparatus according to the first exemplary embodiment of the present invention.

FIG. 3 is a schematic perspective view showing the projection display apparatus according to the first exemplary embodiment of the present invention.

FIG. 4 is an enlarged perspective view showing a wedge prism shown in FIGS. 1A, 1B, and 2.

FIG. 5 is an enlarged side view showing the wedge prism shown in FIGS. 1A, 1B, and 2.

FIG. 6 is an enlarged side view showing the microlens array shown in FIGS. 1A, 1B, and 2.

FIG. 7A is a schematic view showing the applied state of the light flux output from the microlens array shown in FIGS. 1A, 1B, and 2 to the light modulation element.

FIG. 7B is a schematic view showing the applied state of the light flux output from the microlens array shown in FIGS. 1A, 1B, and 2 to the light modulation element.

FIG. 8 is an explanatory schematic side view showing an effect acquired by rotating the wedge prism shown in FIGS. 1A, 1B, and 2.

FIG. 9 is a schematic plan view showing the change of a light irradiation area on the microlens array shown in FIGS. 1A, 1B, and 2.

FIG. 10 is a schematic plan view showing the change of a light irradiation area on the light modulation element shown in FIGS. 1A, 1B, and 2.

FIG. 11 is a schematic side view showing a projection display apparatus according to the second Exemplary Embodiment of the present invention.

FIG. 12 is a schematic side view showing a projection display apparatus according to the third Exemplary Embodiment of the present invention.

FIG. 13 is a schematic plan view showing a projection display apparatus according to the fourth Exemplary Embodiment of the present invention.

FIG. 14 is a schematic perspective view showing the projection display apparatus according to the fourth Exemplary Embodiment of the present invention.

FIG. 15 is a schematic view showing the change of a light irradiation area on a light modulation element shown in FIGS. 13 and 14.

### DESCRIPTION OF EMBODIMENTS

### First Exemplary Embodiment

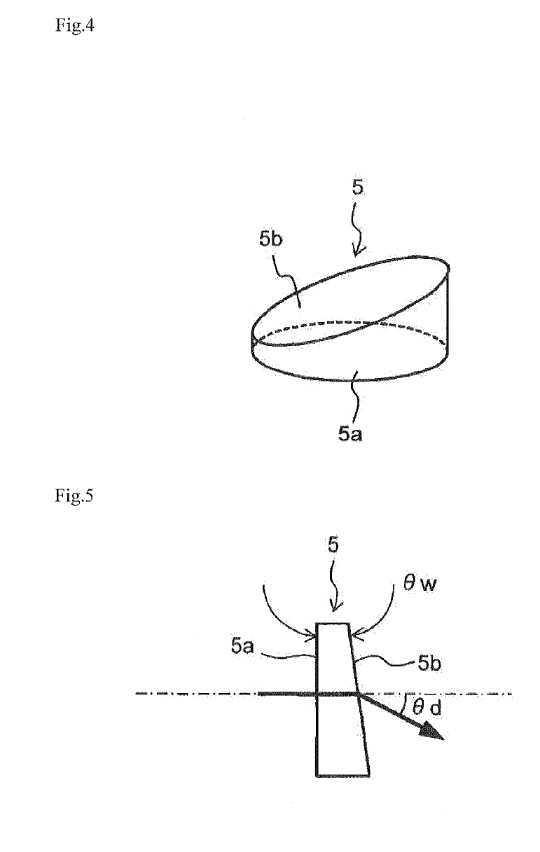

Hereinafter, a projection display apparatus according to the first exemplary embodiment of the present invention will be described. FIG. 2 is a schematic plan view showing the illumination optical system of the projection display apparatus according to the exemplary embodiment. FIG. 3 is a schematic perspective view.

As shown in FIGS. 2 and 3, the projection display apparatus according to the exemplary embodiment includes: semiconductor lasers 2r, 2g, and 2b as light sources; collimator lenses 3r, 3g, and 3b; prisms 4a and 4b; wedge prism 5; driving means (not shown) for rotating wedge prism 5; microlens array 6; illumination area adjusting lens 7; mirror 8; and light modulation element 9.

Semiconductor laser 2r emits a red laser beam, and collimator lens 3r collimates the laser beam emitted from semiconductor laser 2r. Semiconductor laser 2g emits a green laser beam, and collimator lens 3g collimates the laser beam emitted from semiconductor laser 2g. Semiconductor laser 2b emits a blue laser beam, and collimator lens 3b collimates the laser beam emitted from semiconductor laser 2b.

The laser beam (red laser beam) output from collimator lens 3r and the laser beam (green laser beam) output from collimator lens 3g both enter prism 4a. The two laser beams that enter prism 4a exit from the common exit surface of prism 4a. In other words, prism 4a synthesizes the laser beam emitted from semiconductor laser 2r and the laser beam emitted from semiconductor laser 2g.

The laser beam output from prism 4a and the laser beam (blue laser beam) output from collimator lens 3b both enter into prism 4b. The two laser beams that enter prism 4b exit from the common exit surface of prism 4b. In other words, prism 4b synthesizes the laser beam output from prism 4a and the laser beam output from collimator lens 3b. Thus, the laser beams respectively emitted from three semiconductor lasers 2r, 2g, and 2b are synthesized into one laser beam by two prisms 4a and 4b.

Wedge prism 5 made of a glass material has light transmittance of 98% or higher. As shown in FIG. 4, wedge prism 5 includes two optical surfaces 5a and 5b, and second optical surface 5b is inclined with respect to first optical surface 5a. Accordingly, as shown in FIG. 5, light incident on first optical surface 5a of wedge prism 5 exits from second optical surface 5b with a predetermined deflection angle (θd). When the light vertically enters first optical surface 5a, the inclination (apex angle θw) of second optical surface 5b is represented by the following formula. In the formula, “n” denotes a refractive index of wedge prism 5.

θw=arc tan {sin θ/(n−cos θd)}

Referring again to FIGS. 2 and 3, wedge prism 5 having the aforementioned feature is located on the optical axis of the laser beam output from prism 4b so that first optical surface 5a can be an incident surface and second optical surface 5b can be an exit surface. Wedge prism 5 is rotated in a shown arrow direction by the driving means (not shown). The rotational axis of wedge prism 5 is parallel to and incoincident with the optical axis of the laser beam. Effects acquired by rotating wedge prism 5 will be described below in detail.

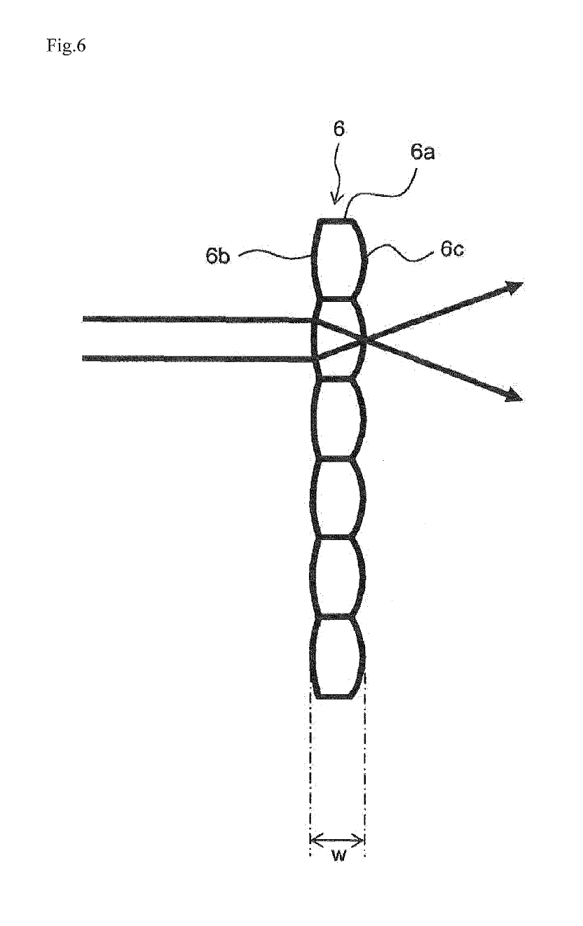

As shown in FIG. 6, microlens array 6 includes a plurality of arrayed rectangular biconvex lenses (microlenses 6a). As shown in FIG. 6, each microlens 6a includes incident surface 6b having curvature R1 and exit surface 6c having curvature R2 (≠R1). The thickness (W) of microlens array 6 is adjusted so that a light flux incident on incident surface 6b of each microlens 6a can be condensed on the apex of exit surface 6c of each microlens 6a.

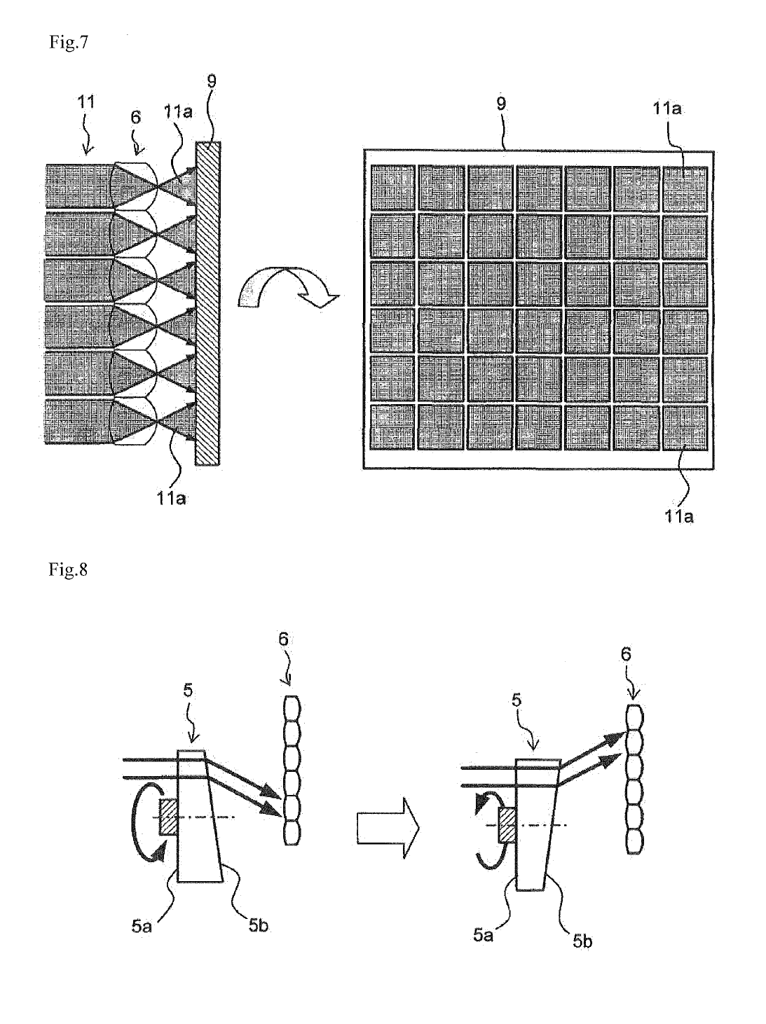

As shown in FIGS. 7A and 7B, laser beam 11 incident on microlens array 6 passes through each microlens 6a to be converted into a plurality of light fluxes 11a. Each light flux 11a output from the exit surface of each microlens 6a is diffused keeping its rectangular shape, and then enters into the illumination area of light modulation element 9. At this time, each light flux 11a is condensed at one point (apex of exit surface 6c of each microlens 6a), and then diffused. Accordingly, luminance is made uniform. In other words, an illuminance distribution in light modulation element 9 is made uniform.

Desirably, parallel light is entered into the microlens array having the aforementioned structure and the optical operation. Thus, the microlens array is compatible with a highly linear laser beam. The microlens array simultaneously achieves beam shaping and uniform luminance, thus contributing to miniaturization of an illumination optical system.

Referring again to FIGS. 2 and 3, a set of light fluxes (laser beams) output from microlens array 6 passes through illumination area adjusting lens land mirror 8 to enter into light modulation element 9. Light modulation element 9 modulates the entered laser beams according to a video signal. The laser beams (image light) modulated by light modulation element 9 are projected to a not-shown screen via a not-shown projection lens. In the exemplary embodiment, light modulation element 9 is a DMD (digital micro-mirror device). Not limited to the DMD, however, light modulation element 9 can be, for example, a liquid crystal panel.

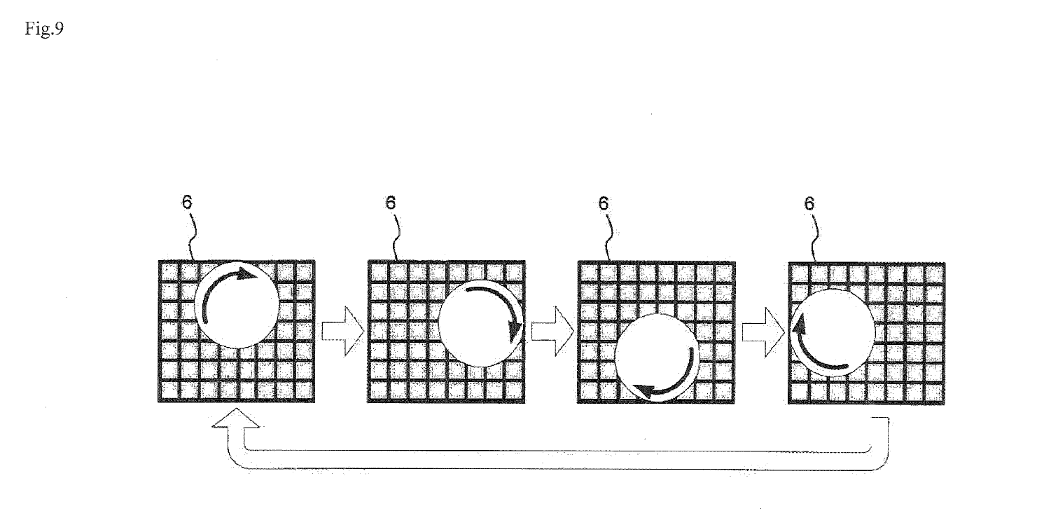

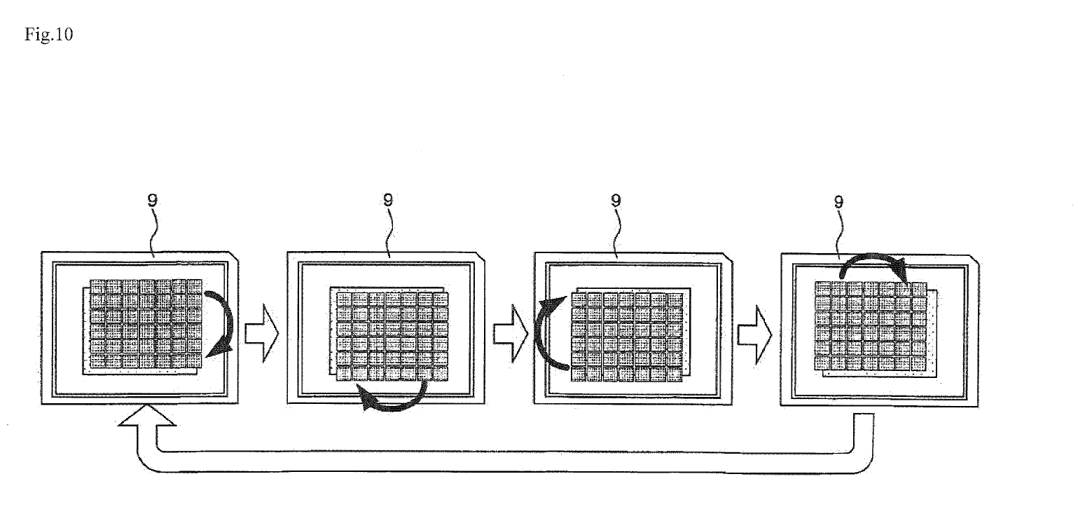

Next, effects acquired by rotating wedge prism 5 will be described in detail. As shown in FIG. 8, wedge prism 5 is rotated at a high speed by the driving means. Accordingly, the inclination direction of second optical surface 5b of wedge prism 5 with respect to microlens array 6 changes with time. In other words, the exit direction of the laser beam output from second optical surface 5b of wedge prism 5 changes with time. Thus, an irradiation position with the laser beam on microlens array 6 changes with time, in other words, vibrates (circular vibration) (FIG. 9). As a result, as shown in FIG. 10, the set of light fluxes output from microlens array 6 also vibrates circularly on light modulation element 9.

Thus, the illuminance distribution in the illumination area of light modulation element 9 is made uniform. Further, since the plurality of light fluxes superimposed in time is modulated by light modulation element 9 to generate image light, speclde noise is prevented.

### Second Exemplary Embodiment

Next, a projection display apparatus according to the second exemplary embodiment of the present invention will be described. The basic configuration of the projection display apparatus according to the exemplary embodiment is similar to that of the projection display apparatus according to the first exemplary embodiment. Thus, description of components similar to those of the projection display apparatus according to the first exemplary embodiment will be omitted, and only different components will be described.

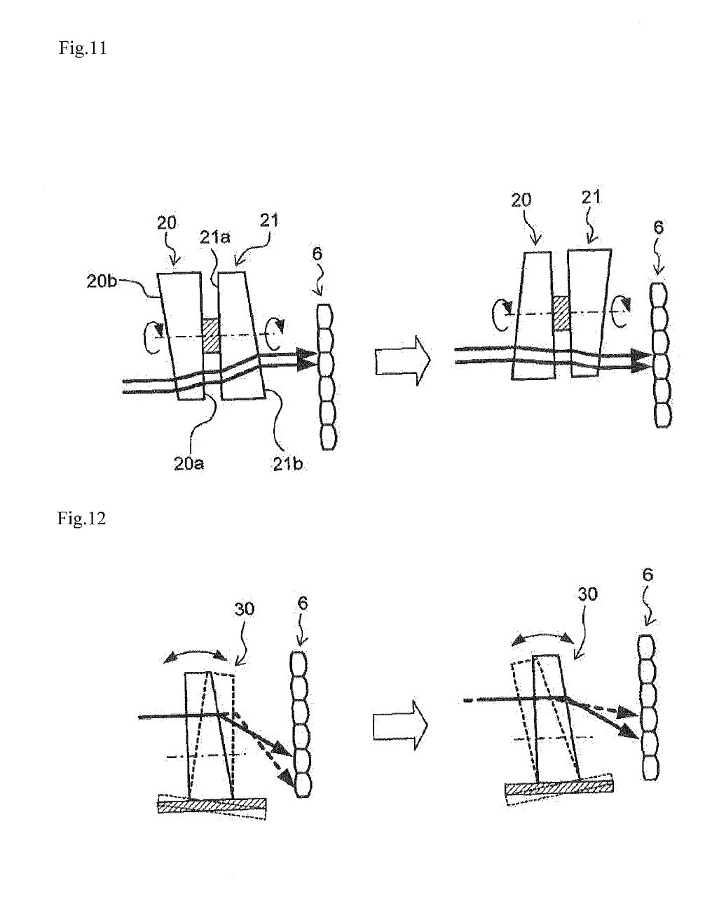

As shown in FIG. 11, the projection display apparatus according to the second exemplary embodiment includes a pair of wedge prisms 20 and 21 having equal apex angles. Wedge prisms 20 and 21 are arranged in this order along the optical axis of a laser beam. Further, wedge prism 20 is located so that inclined second optical surface 20b can be an incident surface and vertical first optical surface 20a can be an exit surface. On the other hand, wedge prism 21 is located so that vertical first optical surface 21a can be an incident surface and inclined second optical surface 2 lb can be an exit surface. In other words, first optical surface 20a of wedge prism 20 and first optical surface 21a of wedge prism 21 face each other.

Wedge prisms 20 and 21 are rotated in the same direction at the same speed by driving means, not-shown. In other words, wedge prisms 20 and 21 rotate without changing the relative positional relationship.

The rotation of wedge prisms 20 and 21 causes a set of light fluxes output from microlens 6 to circularly rotate on light modulation element, not-shown. As a result, the same effects as those of the projection display apparatus according to the first exemplary embodiment can be acquired.

The projection display apparatus according to the exemplary embodiment has the following advantage as compared with the projection display apparatus according to the first exemplary embodiment. That is, by using the pair of wedge prisms 20 and 21, the laser beam incident on microlens array 6 can be collimated to a much greater degree. Thus, light losses at respective microlenses 6a of microlens array 6 are reduced, and light use efficiency is improved.

### Third Exemplary Embodiment

Next, a projection display apparatus according to the third exemplary embodiment of the present invention will be described. Description of components similar to those of the projection display apparatus according to the first exemplary embodiment will be omitted, and only different components will be described.

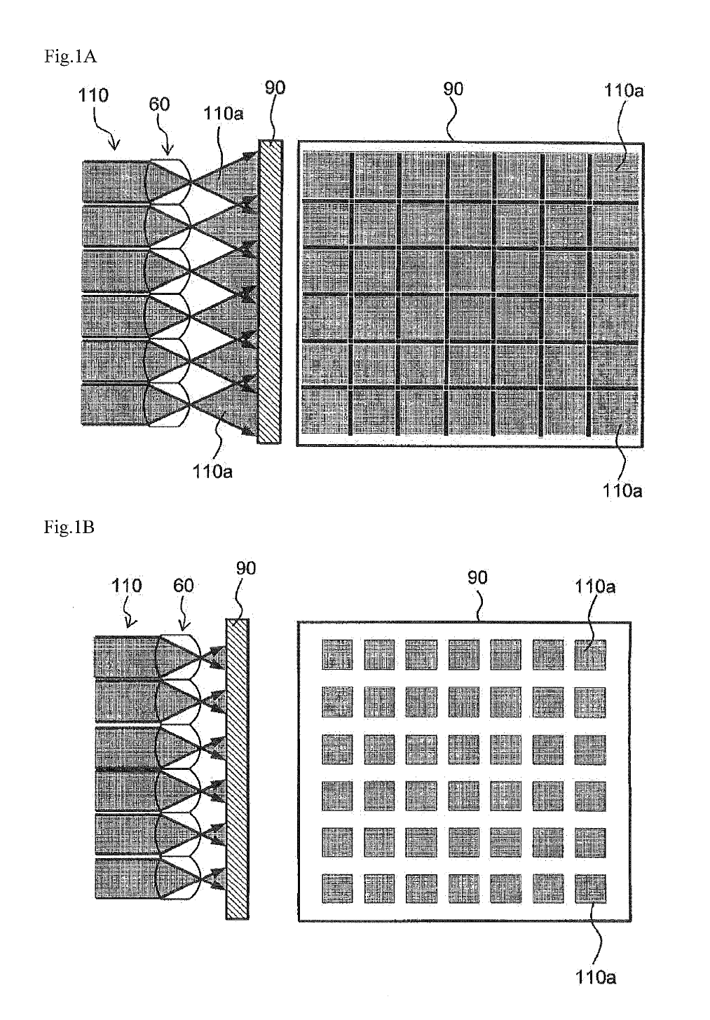

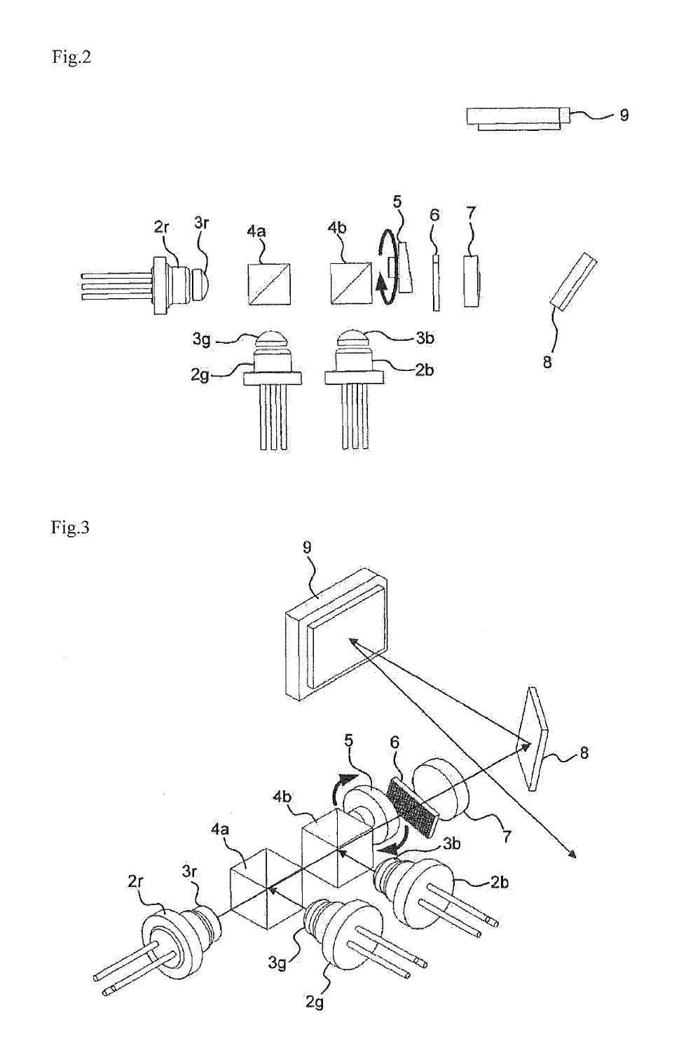

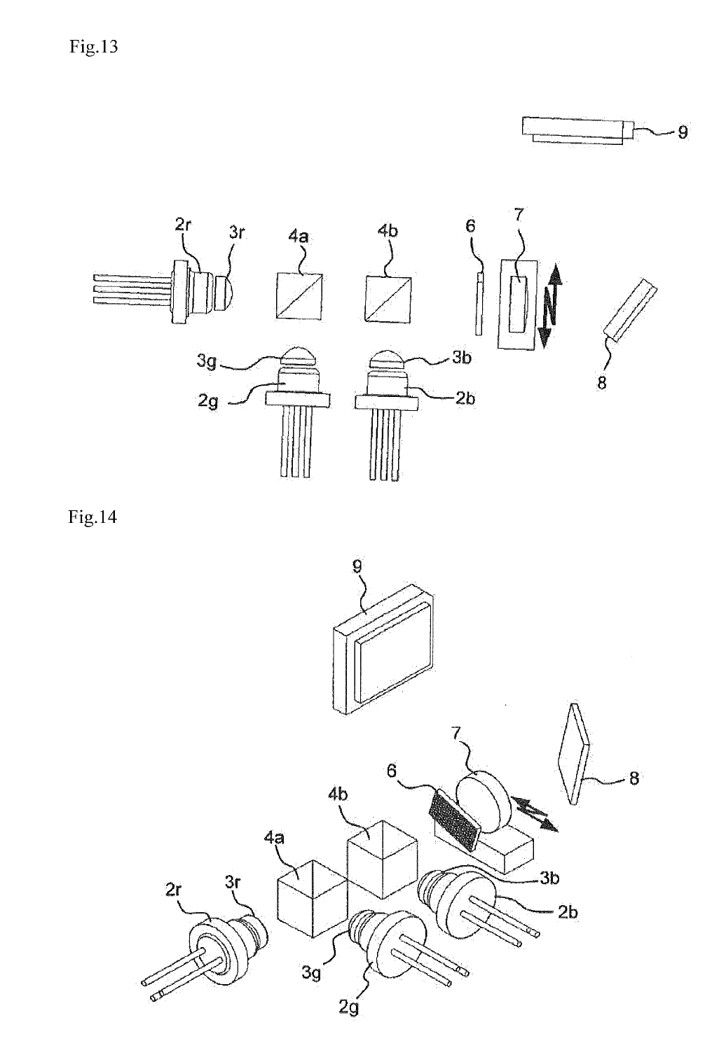

As shown in FIG. 12, the projection display apparatus according to the third exemplary embodiment includes wedge prism 30 similar to wedge prism 5 shown in FIG. 1. However, wedge prism 30 shown in FIG. 12 swings while wedge prism 5 shown in FIG. 1 rotates. Specifically, wedge prism 30 alternately falls back and forth in the optical axis direction of a laser beam. In other words, wedge prism 30 rotates around a rotational axis orthogonal to the optical axis of the laser beam. The swinging of wedge prism 30 is achieved by driving means, not-shown.

The swinging of wedge prism 30 causes a change with time in the irradiation position with the laser beam on microlens array 6, in other words, vibration (linear vibration). Accordingly, as in the case of the first exemplary embodiment, the set of light fluxes output from microlens array 6 linearly vibrates on a light modulation element, not-shown. As a result, the same effects as those of the projection display apparatus according to the first exemplary embodiment can be acquired.

Further, the projection display apparatus according to the exemplary embodiment has the following advantage as compared with the projection display apparatus according to the first exemplary embodiment. That is, since there is no need to rotate the wedge prism on a rotational axis parallel to and incoincident with the optical axis, the wedge prism can be miniaturized. Compact driving means such as a piezoelement, an ultrasonic vibrator, or a compact motor can be used. As a whole, an illumination optical system can be miniaturized much more.

### Fourth Exemplary Embodiment

Next, a projection display apparatus according to the fourth exemplary embodiment of the present invention will be described. FIG. 13 is a schematic plan view showing the illumination optical system of the projection display apparatus according to the exemplary embodiment. FIG. 14 is a schematic perspective view. Components similar to those of the projection display apparatus according to the first exemplary embodiment are denoted by similar reference numerals in FIGS. 13 and 14, and description thereof will be omitted.

As shown in FIGS. 13 and 14, the projection display apparatus according to the exemplary embodiment includes neither wedge prism 5 shown in FIGS. 2 and 3 nor its driving means (not shown). However, the projection display apparatus according to the exemplary embodiment includes illumination area adjusting lens 7, and driving means, not-shown, for swinging illumination area adjusting lens 7 vertically, horizontally, or back and forth.

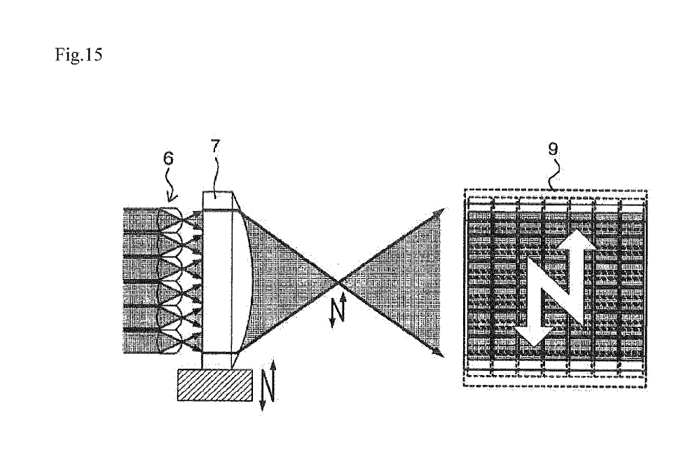

By swinging illumination area adjusting lens 7 as described above, a laser beam applied to light modulation element 9 can be vibrated. Thus, the same effects as those of the projection display apparatus according to the first exemplary embodiment can be acquired (FIG. 15).

Further, the projection display apparatus according to the exemplary Embodiment has the following advantage as compared with the projection display apparatus according to the first exemplary embodiment. That is, since a wedge prism is unnecessary, the structure of the illumination optical system is simple, thus achieving miniaturization and low cost.

Illumination area adjusting lens 7 can be swung in two or three directions. For example, illumination area adjusting lens 7 can be swung back and forth and horizontally. As the driving means for swinging illumination area adjusting lens 7, a piezoelement, an ultrasonic vibrator, or a compact motor can be used.

1. A projection display apparatus that enlarges and projects an image, comprising:
a semiconductor laser as a light source;
a first optical element that refracts light emitted from the semiconductor laser and outputs the light in a direction different from an incident direction;
a second optical element that converts the light output from the first optical element into a plurality of light fluxes;
a light modulation element that modulates the light output from the second optical element to generate image light; and
driving means that rotates or swings the first optical element,
wherein rotating or swinging the first optical element causes a change with time in irradiation position of the second optical element with the light output from the first optical element.

2. The projection display apparatus according to claim 1, wherein:
the first optical element comprises a wedge prism including a first optical surface and a second optical surface inclined with respect to the first optical surface; and
the wedge prism is located so that the first optical surface can be vertical to an optical axis of the light emitted from the semiconductor laser and the second optical surface can face a light incident surface of the second optical element.

3. The projection display apparatus according to claim 1, wherein:
the first optical element includes two wedge prisms each including a first optical surface and a second optical surface inclined with respect to the first optical surface;
the two wedge prisms are arranged adjacently to each other so that the first optical surfaces face each other and the second optical surfaces are parallel to each other; and
the driving means rotates or swings the two wedge prisms in the same direction at the same speed.

4. The projection display apparatus according to claim 1, further comprising a plurality of semiconductor lasers and a third optical element that synthesizes lights emitted from the semiconductor lasers,
wherein the light synthesized by the third optical element enters the first optical element.

5. The projection display apparatus according to claim 1,
wherein the second optical element comprises a microlens array.

6. A projection display apparatus that enlarges and projects an image, comprising:
a semiconductor laser as a light source;
a first optical element that converts light emitted from the semiconductor laser into a plurality of light fluxes;
a second optical element through which light output from the first optical element passes;
a light modulation element that modulates the light output from the second optical element to generate image light; and
driving means that swings the second optical element,
wherein swinging the second optical element causes a change with time in irradiation position of the light modulation element with the light output from the second optical element.

7. The projection display apparatus according to claim 6, further comprising a plurality of semiconductor lasers and a third optical element that synthesizes lights emitted from the semiconductor lasers,
wherein the light synthesized by the third optical element enters the first optical element.

8. The projection display apparatus according to claim 6,
wherein the second optical element is swung in two different directions.

9. The projection display apparatus according to claim 6,
wherein the second optical element comprises a microlens array.

10. The projection display apparatus according to claim 2,
wherein the second optical element comprises a microlens array.

11. The projection display apparatus according to claim 3,
wherein the second optical element comprises a microlens array.

12. The projection display apparatus according to claim 4,
wherein the second optical element comprises a microlens array.

13. The projection display apparatus according to claim 7,
wherein the second optical element is swung in two different directions.

14. The projection display apparatus according to claim 7,
wherein the second optical element comprises a microlens array.

15. The projection display apparatus according to claim 8,
wherein the second optical element comprises a microlens array.

16. The projection display apparatus according to claim 13,
wherein the second optical element comprises a microlens array.
